(19) United States
(12) Patent Application Publication
(10) Pub. No.: US 2009/0085308 A1
(43) Pub. Date: Apr. 2, 2009

(54) Tool connector having different driving members

(75) Inventor: Wen Hung Chiang, Taichung Hsien (TW)

Correspondence Address: CHARLES E. BAXLEY, ESQUIRE, 90 JOHN STREET, SUITE 309, NEW YORK, NY, 10038, US

(73) Assignee: Hsin Ying Enterprise Co., Ltd.

(21) Appl. No.: 11/906,290

(22) Filed: Oct. 1, 2007

(51) Int. Cl. B25G 3/10

(52) U.S. Cl. 279/102

(57) ABSTRACT

A tool connector includes a outer sleeve having a noncircular bore, and a tool shank slidably engaged in the bore of the outer sleeve and having two end portions slidably engaged in the bore at two end portions of the outer sleeve and extendible out of the end portions of the outer sleeve for engaging with different tool elements or for driving different tool elements. One of the end portions of the tool shank may be engaged into the bore of the outer sleeve when the other end portion of the tool shank is extended out of the outer sleeve for allowing a tool member to be engaged with the bore of the outer sleeve and for allowing different tool elements to be driven by the tool connector.

### BACKGROUND OF THE INVENTION

1. Field of the Invention

The present invention relates to a tool connector, and more particularly to a tool connector including a shank slidably engaged in an outer sleeve and having two ends of different engaging members selectively extendible out of the outer sleeve for engaging with different tool elements and for driving different tool elements.

2. Description of the Prior Art

Typical tool devices comprise a tool shank having an engaging hole formed in one end portion thereof for receiving or engaging with a tool bit that includes a predetermined dimension or outer diameter and for driving the tool bit.

For example, U.S. Pat. No. 3,935,762 to Tudisco discloses one of the typical tool assemblies for mounting bits and comprising a tubular shank with an enlarged end portion in which is seated a tool bit receiving socket, and the socket includes a cavity opening at the other end in which is seated the tool bits.

However, the cavity of the socket or the tool shank may be provided for receiving or engaging with the tool bit that includes a predetermined dimension or outer diameter, and may not be used for driving the other tool bits or tool elements.

U.S. Pat. No. 5,724,872 to Shih discloses another typical socket spanner including a socket having an engaging hole formed in one end portion thereof for receiving or engaging with a driven member, and another engaging hole formed in the other end portion thereof for receiving or engaging with a driving tool.

However, the engaging hole at one end portion of the socket may be provided for receiving or engaging with the driven member that includes a predetermined dimension or outer diameter and may not be used for driving the other driven members of different outer diameter; and the engaging hole at the other end portion of the socket may be provided for receiving or engaging with the driving tool that includes a predetermined dimension or outer diameter and may not be used for driving the other driving tools of different outer diameter.

The present invention has arisen to mitigate and/or obviate the afore-described disadvantages of the conventional tool connectors or tool devices.

### SUMMARY OF THE INVENTION

The primary objective of the present invention is to provide a tool connector including a shank slidably engaged in an outer sleeve and having two ends of different engaging members selectively extendible out of the outer sleeve for engaging with different tool elements and for driving different tool elements.

In accordance with one aspect of the invention, there is provided a tool connector comprising a outer sleeve including a bore formed therein and having a noncircular cross section, and including a first end portion and a second end portion, and a tool shank slidably received and engaged in the bore of the outer sleeve, and including a first end portion slidably received and engaged in the bore at the first end portion of the outer sleeve and extendible out of the first end portion of the outer sleeve for engaging with a tool element, and including a second end portion slidably received and engaged in the bore at the second end portion of the outer sleeve and extendible out of the second end portion of the outer sleeve and having a cross section different from that of the first end portion of the tool shank for engaging with a driving tool, and the first end portion of the tool shank is engaged into the bore of the outer sleeve when the second end portion of the tool shank is extended out of the second end portion of the outer sleeve for allowing a driven tool member to be engaged with the bore at the first end portion of the outer sleeve, and the second end portion of the tool shank is engaged into the bore of the outer sleeve when the first end portion of the tool shank is extended out of the first end portion of the outer sleeve for allowing a tool stem to be engaged with the bore at the second end portion of the outer sleeve and for allowing the first end portion of the tool shank to engage with the tool element.

The bore of the outer sleeve includes a polygonal cross section for receiving and engaging with the first end portion and the second end portion of the tool shank and for allowing either the first end portion or the second end portion of the tool shank to be rotated and driven by the outer sleeve.

The outer sleeve includes a non-circular engaging portion provided on an outer portion thereof for engaging with another driving tool. The tool shank includes a spring-biased projection engaged therein and extendible out of the tool shank for engaging with the tool element.

The tool shank includes a magnetic member engaged therein for attracting and retaining the driven tool member to the tool shank. The tool shank includes an orifice for receiving and engaging with a barrel, and the magnetic member is engaged in the barrel.

The tool shank includes a retaining ring attached thereto for engaging with the outer sleeve and for limiting the tool shank to slide relative to the outer sleeve and for preventing the tool shank from being disengaged from the outer sleeve.

The outer sleeve includes at least one first ratchet recess formed in the first end portion of the outer sleeve, and at least one second ratchet recess formed in the second end portion of the outer sleeve for engaging with the retaining ring and for limiting the tool shank to slide relative to the outer sleeve.

The bore at the first end portion of the outer sleeve may include an inner diameter either smaller or greater than that of the bore at the second end portion of the outer sleeve.

The first end portion of the tool shank may include an outer diameter either smaller or greater than that of the second end portion of the tool shank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tool connector in accordance with the present invention;

FIG. 2 is another partial exploded view of the tool connector;

FIGS. 3, 4, 5 are cross sectional views of the tool connector taken along lines 3-3, 4-4, 5-5 of FIG. 1 respectively;

FIG. 6 is a cross sectional view similar to FIG. 5 illustrating the operation of the tool connector;

FIG. 7 is a perspective view illustrating the other arrangement of the tool connector;

FIG. 8 is a cross sectional view of the tool connector taken along lines 8-8 of FIG. 7;

FIG. 9 is a perspective view illustrating the further arrangement of the tool connector; and

FIG. 10 is a cross sectional view of the tool connector taken along lines 10-10 of FIG. 9.

### DETAILED DESCRIPTION OF THE PREFERRED EMBODIMENT

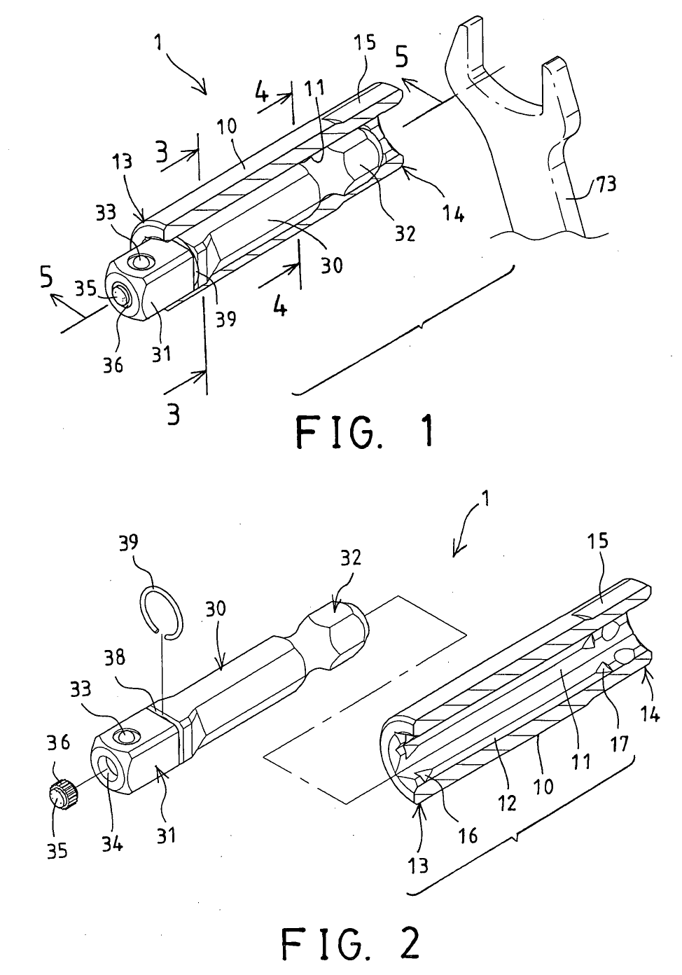

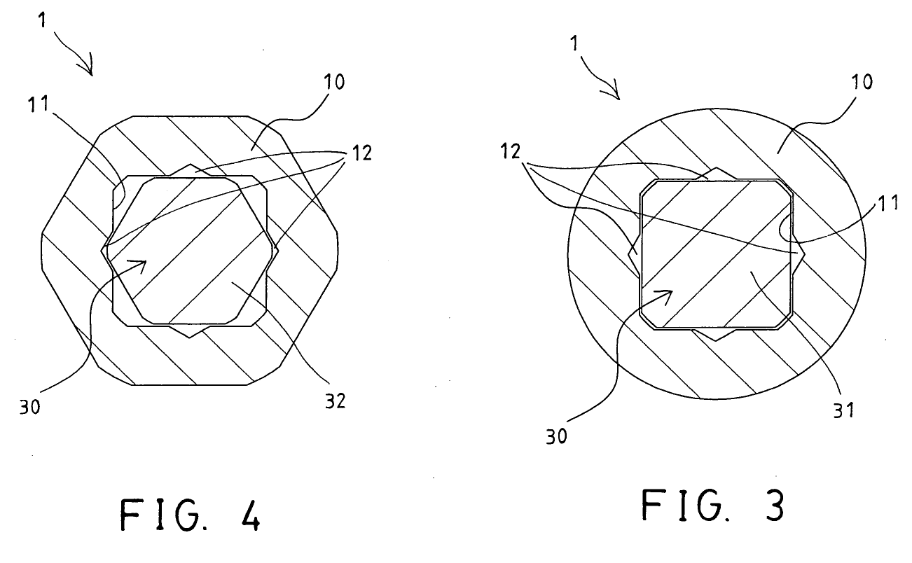

Referring to the drawings, and initially to FIGS. 1-5, a tool connector 1 in accordance with the present invention comprises an outer sleeve 10 including a bore 11 longitudinally formed therein and having a noncircular cross section, such as a substantially square cross section for slidably receiving or engaging with one end portion 31 of a tool shank 30 that includes a noncircular cross section, such as a square cross section corresponding to that of the bore 11 of the outer sleeve 10 for allowing the one end portion 31 of the tool shank 30 to be rotated or driven by the outer sleeve 10, and the outer sleeve 10 includes one or more longitudinal groove 12 formed therein (FIGS. 3, 4) and communicating with the bore 11 of the outer sleeve 10 for forming a polygonal cross section and for receiving or engaging with the other end portion 32 of the tool shank 30 that includes a hexagonal or octagonal cross section corresponding to that of the polygonal cross section of the bore 11 of the outer sleeve 10 for allowing the other end portion 32 of the tool shank 30 also to be rotated or driven by the outer sleeve 10.

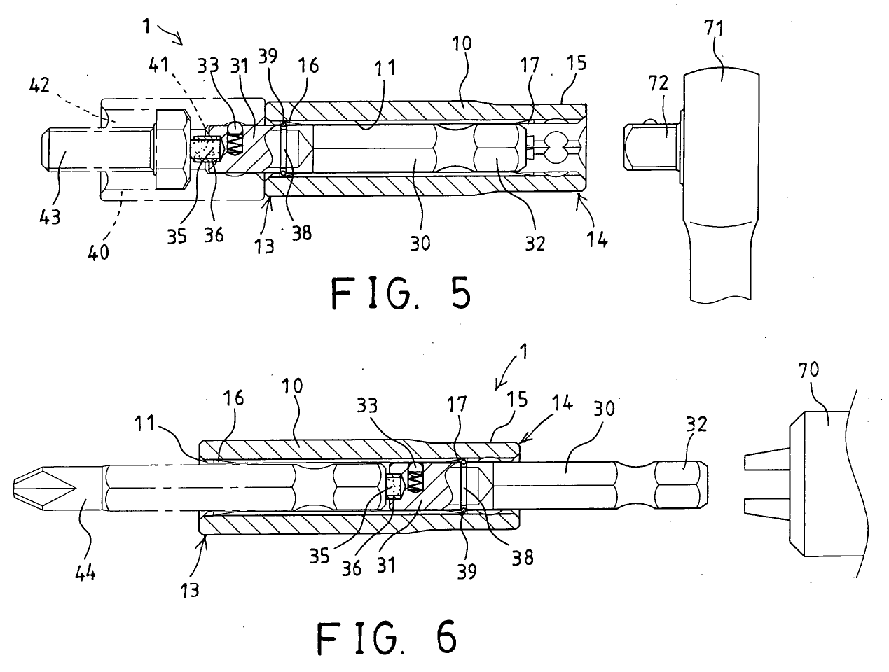

It is preferable that the one end portion 31 of the tool shank 30 is slidably received in one end portion 13 of the outer sleeve 10 and extendible out of the one end portion 13 of the outer sleeve 10 for engaging with an engaging hole 41 of a socket or other tool elements 40 (FIG. 5) and for driving the tool elements 40 which may include another engaging hole 42 formed in the other end portion thereof for receiving or engaging with a driven tool member 43. The other end portion 32 of the tool shank 30 is slidably received in the other end portion 14 of the outer sleeve 10 and extendible out of the other end portion 14 of the outer sleeve 10 (FIG. 6) for engaging with a driving tool 70 and for allowing the tool shank 30 and thus the outer sleeve 10 to be selectively rotated or driven by the driving tool 70.

In operation, as shown in FIG. 5, when the one end portion 31 of the tool shank 30 is extended out of the one end portion 13 of the outer sleeve 10, the other end portion 32 of the tool shank 30 may be received or engaged into the other end portion 14 of the outer sleeve 10, and the one end portion 31 of the tool shank 30 may be engaged with the engaging hole 41 of the tool element 40 for driving the tool elements 40 and the driven tool member 43 which is received or engaged in the engaging hole 42 of the tool element 40, and another driving tool 71 may include a tool stem 72 for engaging with or into the bore 11 at the other end portion 14 of the outer sleeve 10 and for rotating or driving the outer sleeve 10 and the tool shank 30 and the tool elements 40.

On the contrary, as shown in FIG. 6, when the other end portion 32 of the tool shank 30 is extended out of the other end portion 14 of the outer sleeve 10, the one end portion 31 of the tool shank 30 may be received or engaged into the one end portion 13 of the outer sleeve 10, and the other end portion 32 of the tool shank 30 may be engaged with the driving tool 70 for allowing the tool shank 30 and thus the outer sleeve 10 to be selectively rotated or driven by the driving tool 70. The other driven tool members 44 may be received or engaged into the bore 11 at the one end portion 13 of the outer sleeve 10 for allowing the other driven tool members 44 also to be selectively rotated or driven by the driving tool 70.

It is preferable that the outer sleeve 10 includes a non-circular engaging portion or segment 15 provided or formed on the outer portion thereof at such as the other end portion 14 of the outer sleeve 10 for engaging with a further driving tool 73 (FIG. 1), such as a wrench or spanner and for allowing the outer sleeve 10 and thus the tool shank 30 to be selectively rotated or driven by the driving tool 73. The tool shank 30 may further include a spring-biased projection 33 engaged therein and laterally extendible out of the tool shank 30 for engaging with the tool elements 40 and for retaining the tool elements 40 to the tool shank 30, and may further include an orifice 34 formed in the one end portion 31 of the tool shank 30 receiving or engaging with a magnetic member 35 which may be engaged in a barrel 36 and then secured in the orifice 34 of the tool shank 30 for attracting or retaining the driven tool member 43 to the tool elements 40 and to the tool shank 30.

The outer sleeve 10 may include one or more limit or ratchet recesses 16 formed in the one end portion 13 of the outer sleeve 10 and communicating with the bore 11 of the outer sleeve 10, and one or more further limit or ratchet recesses 17 formed in the other end portion 14 of the outer sleeve 10 and also communicating with the bore 11 of the outer sleeve 10, and the tool shank 30 may further include a peripheral slot 38 formed in the outer peripheral portion thereof for engaging with a retaining ring 39 which may be selectively engaged with either the ratchet recesses 16 at the one end portion 13 of the outer sleeve 10 (FIGS. 1, 5) or the ratchet recesses 17 at the other end portion 14 of the outer sleeve 10 (FIG. 6) for limiting the tool shank 30 to slide relative to the outer sleeve 10 and for preventing the tool shank 30 from being disengaged from the outer sleeve 10.

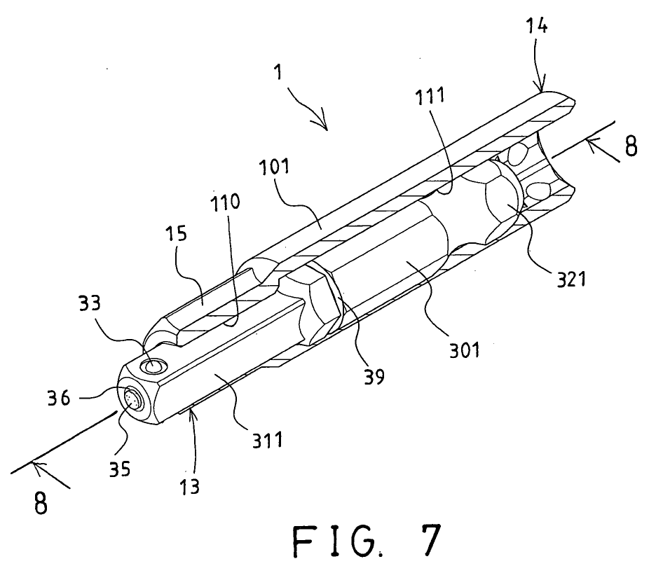

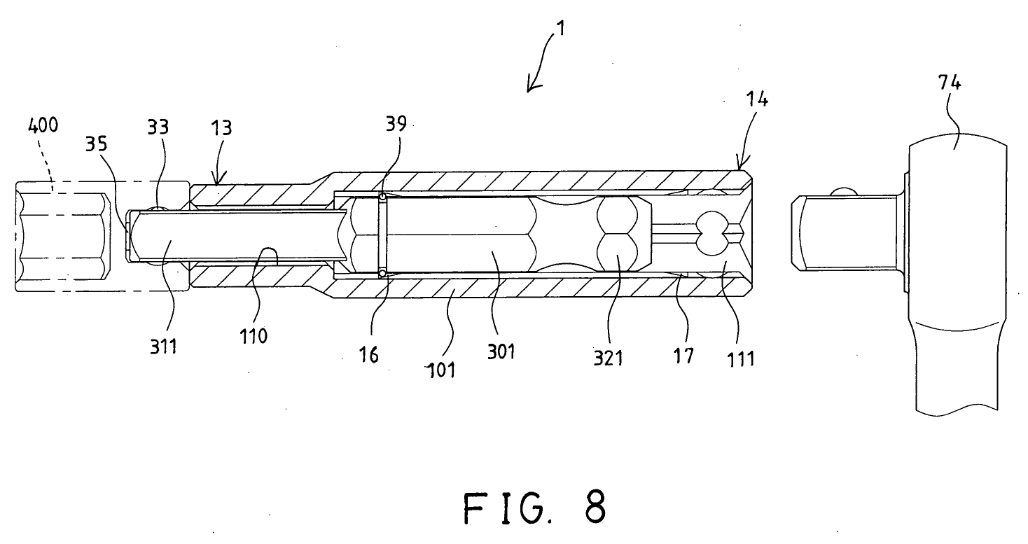

Alternatively, as shown in FIGS. 7 and 8, the bore 110 at the one end portion 13 of the outer sleeve 101 may include a relatively reduced inner diameter for receiving or engaging with the one end portion 311 of the tool shank 301 that also includes a corresponding or relatively reduced outer diameter for allowing the one end portion 311 of the tool shank 301 to be rotated or driven by the outer sleeve 101 and to be extended out of the one end portion 13 of the outer sleeve 101 for engaging with another tool element 400; and the bore 111 at the other end portion 14 of the outer sleeve 101 may include a relatively increased inner diameter for receiving or engaging with the other end portion 321 of the tool shank 301 that also includes a corresponding or relatively increased outer diameter for allowing the other end portion 321 of the tool shank 301 to be rotated or driven by the outer sleeve 101 and to be extended out of the other end portion 14 of the outer sleeve 101 for engaging with another driving tool 74.

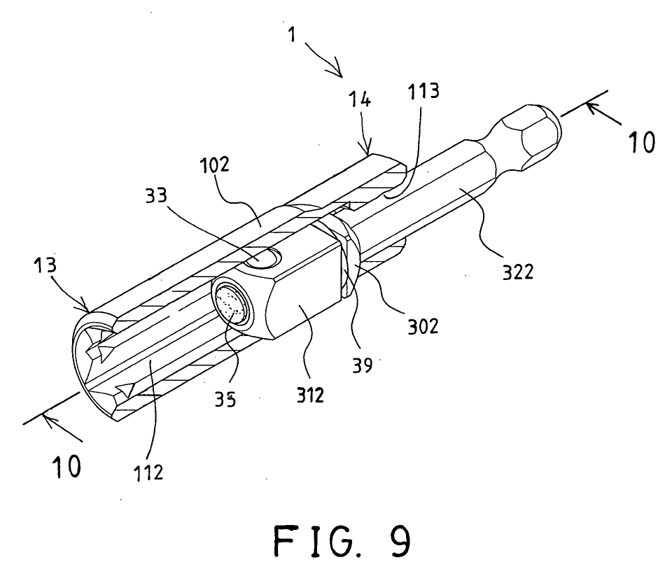

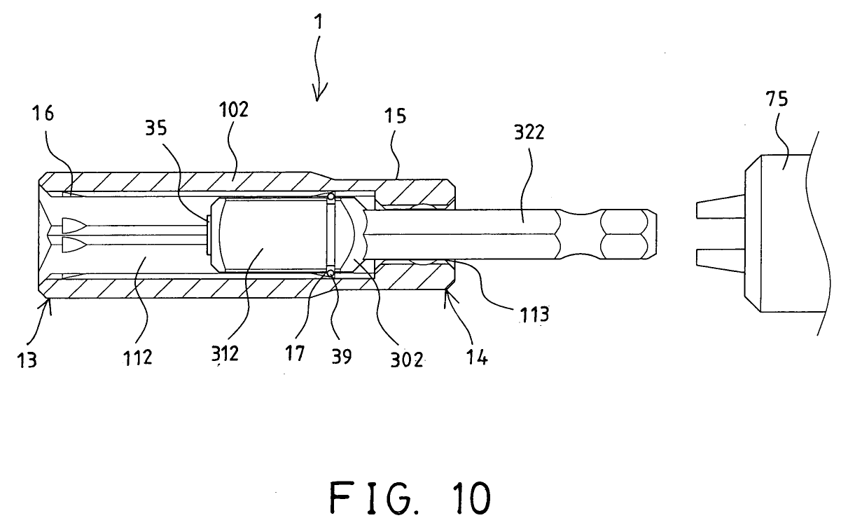

Further alternatively, as shown in FIGS. 9 and 10, the bore 112 at the one end portion 13 of the outer sleeve 102 may include a relatively increased inner diameter for receiving or engaging with the one end portion 312 of the tool shank 302 that also includes a corresponding or relatively increased outer diameter for allowing the one end portion 312 of the tool shank 302 to be rotated or driven by the outer sleeve 102 and to be extended out of the one end portion 13 of the outer sleeve 102 for engaging with another tool element (not shown); and the bore 113 at the other end portion 14 of the outer sleeve 102 may include a relatively reduced inner diameter for receiving or engaging with the other end portion 322 of the tool shank 302 that also includes a corresponding or relatively reduced outer diameter for allowing the other end portion 322 of the tool shank 302 to be rotated or driven by the outer sleeve 102 and to be extended out of the other end portion 14 of the outer sleeve 102 for engaging with a further driving tool 75.

It is to be noted that the tool shank 30, 301, 302 includes two end portions 31, 32; 311, 321; 312, 322 of different cross sections slidably received or engaged in the two end portions 13, 14 of the outer sleeve 10, 101, 102 and selectively extendible out of the two end portions 13, 14 of the outer sleeve 10, 101, 102 respectively and for engaging with different tool elements 40 and/or driven tool members 43, 44 or for engaging with different driving tools 70, 71, 73, 74, 75, and thus for allowing the tool shank 30, 301, 302 and the outer sleeve 10, 101, 102 to be used for engaging with or for driving different tool elements 40 and/or driven tool members 43, 44 and to be selectively engaged with or driven by different driving tools 70, 71, 73, 74, 75.

Accordingly, the tool connector in accordance with the present invention includes a shank slidably engaged in an outer sleeve and having two ends of different engaging members selectively extendible out of the outer sleeve for engaging with different tool elements and for driving different tool elements.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool connector comprising:
a outer sleeve including a bore formed therein and having a noncircular cross section, and including a first end portion and a second end portion, and
a tool shank slidably received and engaged in said bore of said outer sleeve, and including a first end portion slidably received and engaged in said bore at said first end portion of said outer sleeve and extendible out of said first end portion of said outer sleeve for engaging with a tool element, and including a second end portion slidably received and engaged in said bore at said second end portion of said outer sleeve and extendible out of said second end portion of said outer sleeve and having a cross section different from that of said first end portion of said tool shank for engaging with a driving tool, and
said first end portion of said tool shank being engaged into said bore of said outer sleeve when said second end portion of said tool shank is extended out of said second end portion of said outer sleeve for allowing a driven tool member to be engaged with said bore at said first end portion of said outer sleeve, and said second end portion of said tool shank being engaged into said bore of said outer sleeve when said first end portion of said tool shank is extended out of said first end portion of said outer sleeve for allowing a tool stem to be engaged with said bore at said second end portion of said outer sleeve and for allowing said first end portion of said tool shank to engage with the tool element.

2. The tool connector as claimed in claim 1, wherein said bore of said outer sleeve includes a polygonal cross section for receiving and engaging with said first end portion and said second end portion of said tool shank and for allowing either said first end portion or said second end portion of said tool shank to be rotated and driven by said outer sleeve.

3. The tool connector as claimed in claim 1, wherein said outer sleeve includes a non-circular engaging portion provided on an outer portion thereof for engaging with another driving tool.

4. The tool connector as claimed in claim 1, wherein said tool shank includes a spring-biased projection engaged therein and extendible out of said tool shank for engaging with the tool element.

5. The tool connector as claimed in claim 1, wherein said tool shank includes a magnetic member engaged therein for attracting and retaining the driven tool member to said tool shank.

6. The tool connector as claimed in claim 5, wherein said tool shank includes an orifice for receiving and engaging with a barrel, and said magnetic member is engaged in said barrel.

7. The tool connector as claimed in claim 1, wherein said tool shank includes a retaining ring attached thereto for engaging with said outer sleeve and for limiting said tool shank to slide relative to said outer sleeve and for preventing said tool shank from being disengaged from said outer sleeve.

8. The tool connector as claimed in claim 7, wherein said outer sleeve includes at least one first ratchet recess formed in said first end portion of said outer sleeve, and at least one second ratchet recess formed in said second end portion of said outer sleeve for engaging with said retaining ring and for limiting said tool shank to slide relative to said outer sleeve.

9. The tool connector as claimed in claim 1, wherein said bore at said first end portion of said outer sleeve includes an inner diameter smaller than that of said bore at said second end portion of said outer sleeve.

10. The tool connector as claimed in claim 1, wherein said bore at said first end portion of said outer sleeve includes an inner diameter greater than that of said bore at said second end portion of said outer sleeve.

11. The tool connector as claimed in claim 1, wherein said first end portion of said tool shank includes an outer diameter smaller than that of said second end portion of said tool shank.

12. The tool connector as claimed in claim 1, wherein said first end portion of said tool shank includes an outer diameter greater than that of said second end portion of said tool shank.
